(19) United States
(12) Patent Application Publication
(10) Pub. No.: US 2024/0303566 A1
(43) Pub. Date: Sep. 12, 2024

(54) INTELLIGENT LOGISTICS TRUCK SCHEDULING SYSTEM PROCESS

(71) Applicants: Zhen-sheng Wang, SANTA FE SPRINGS, CA (US); Ze-Nong Wang, SANTA FE SPRINGS, CA (US); Ze-Feng Wang, SANTA FE SPRINGS, CA (US)

(72) Inventors: Zhen-sheng Wang, SANTA FE SPRINGS, CA (US); Ze-Nong Wang, SANTA FE SPRINGS, CA (US); Ze-Feng Wang, SANTA FE SPRINGS, CA (US)

(21) Appl. No.: 18/118,717

(22) Filed: Mar. 7, 2023

(51) Int. Cl. G06Q 10/0631; G06Q 10/0833; G06Q 10/0834; G06Q 30/04

(52) U.S. Cl. CPC G06Q 10/06315; G06Q 10/0833; G06Q 10/0834; G06Q 30/04

(57) ABSTRACT

An intelligent logistics truck scheduling system process includes a demand judgement step, a truck scheduling, container lifting and delivery step, a storage judgement step, and a billing and payment step. Compared to the previous truck scheduling systems, most of the steps have been changed to automation. This improves the efficiency of the truck scheduling system in operation by reducing the need for human communication through various means such as email, phone, and text messages with clients, truck companies, and drivers for coordinating truck pickup times and locations repeatedly.

### BACKGROUND OF THE INVENTION

### 1. Fields of the Invention

The present invention relates to an intelligent logistics truck scheduling system process so as to quickly find trucks and drivers to proceed the process of products pick-up and delivery.

### 2. Descriptions of Related Art

Logistics systems are of high importance in today's society. This is because with the advancement of technology, e-commerce platforms, mobile stores and other online shopping techniques have become mature, resulting in a high degree of dependence on online shopping. This has also led to a proportional increase in the workload of logistics. The impact caused by the deficiencies in previous logistics systems has become more pressing and in need of resolution.

For example, traditional truck scheduling operations require multiple means of communication such as email, phone, and text messages to repeatedly communicate with clients about truck pickup times and locations. At the same time, truck scheduling companies also need to search and contact relevant trucks and drivers through various platforms, plan and arrange for trucks and drivers to arrive at designated times and locations to perform pickup and transportation operations. This method of operation is inefficient, time-consuming and labor-intensive, and significantly affects the speed of data processing and operational operations.

The present invention intends to provide an intelligent logistics truck scheduling system process to eliminate the shortcomings mentioned above.

### SUMMARY OF THE INVENTION

The present invention relates to an intelligent logistics truck scheduling system and comprises a truck service section, a truck scheduling section, and a storage service section. The truck scheduling section includes a truck company database, an idle truck monitoring module, a truck distance judgment module, a truck selection module, and a truck assignment module.

The intelligent logistics truck scheduling system process comprises a demand judgment step, a truck scheduling, container lifting and delivery step, a storage judgment step, and a billing and payment step. The demand judgment step is that a demand judgment module of a truck service section judges whether a client needs a truck service. If the truck service is not needed, a billing and payment step is proceeded. If the truck service is needed, the truck scheduling, container lifting and delivery step is proceeded. The truck scheduling, container lifting and delivery step is that the truck service section includes a truck scheduling section which reads a truck company database to obtain a truck information and a driver information. The truck scheduling section uses a network module of the truck service section to connect to multiple truck companies networks. An idle truck monitoring module is used to monitor idle trucks and idle drivers of the truck companies in real-time. A truck distance judgment module is used to judge a distance between a container lifting location and each idle truck. A truck selection module then selects the truck that is located closest to the container lifting location and sends a corresponding information to a truck assignment module. The truck assignment module sends an instruction to the selected truck and the driver through internet to carry out container lifting and delivery. After assignment, a truck tracking section is used to determine a current transportation location of the container. After the truck scheduling, container lifting, and delivery step is completed, the storage judgment step is proceeded. The storage judgment step is that a storage demand judgment module of a storage service section judges whether the client has a storage demand. If no storage demand is needed, the billing and payment step is proceeded. If a storage demand is needed, after goods stored in a warehouse and a warehouse management is completed, the billing and payment step is proceeded. The billing and payment step is that the truck service section consolidates funds and issues a bill for payment to the client.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the steps of the intelligent logistics truck scheduling system process of the present invention;

FIG. 2 shows the flow chart between the client and the intelligent logistics truck scheduling system process of the present invention, and

FIG. 3 shows the components of the intelligent logistics truck scheduling system process of the present invention.

### DETAILED DESCRIPTION OF THE PREFERRED EMBODIMENT

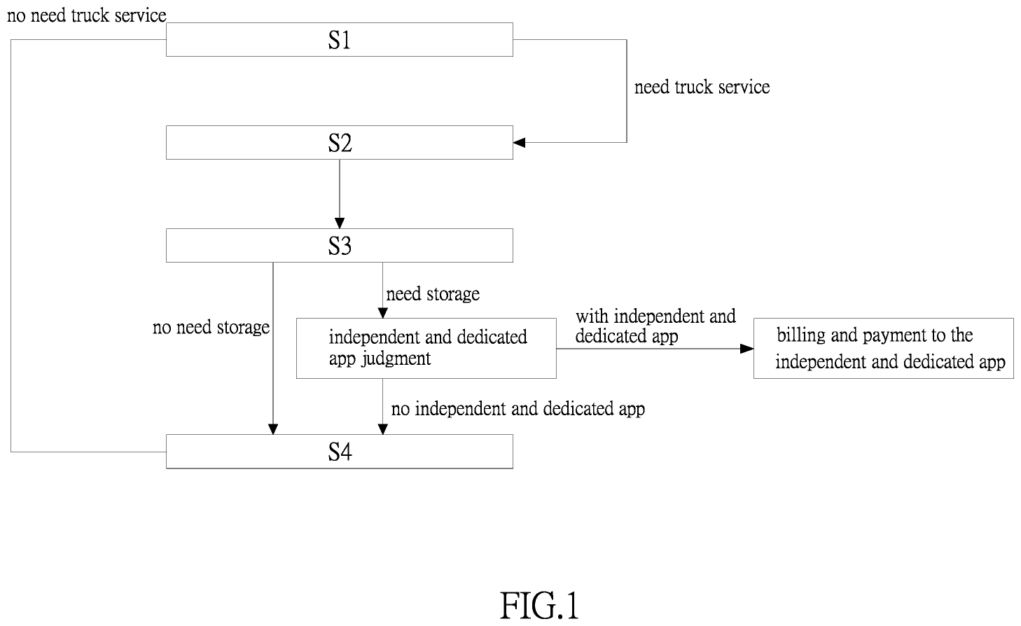

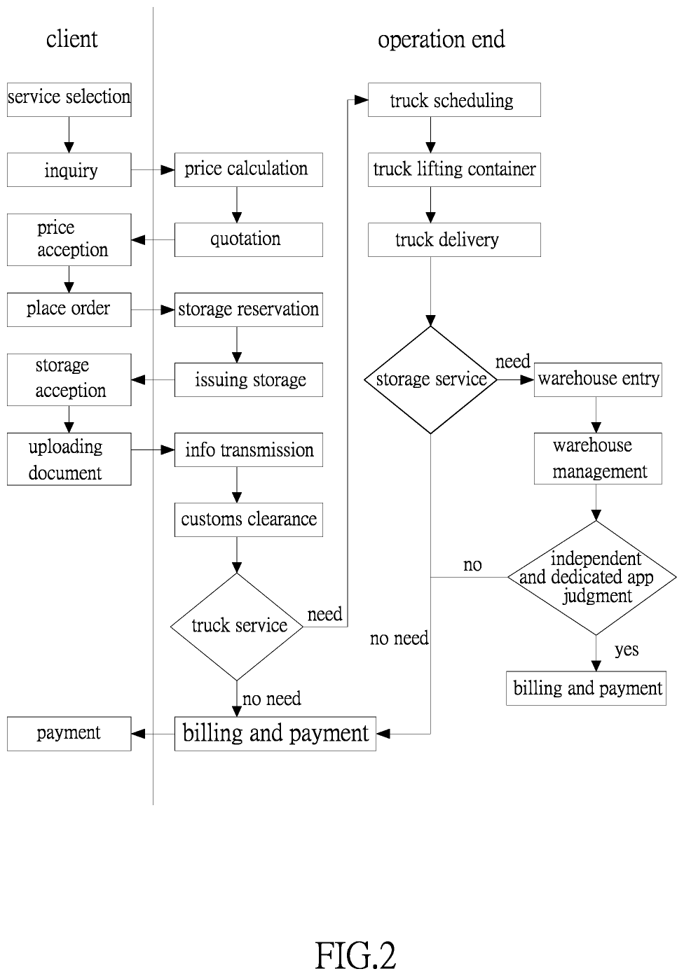

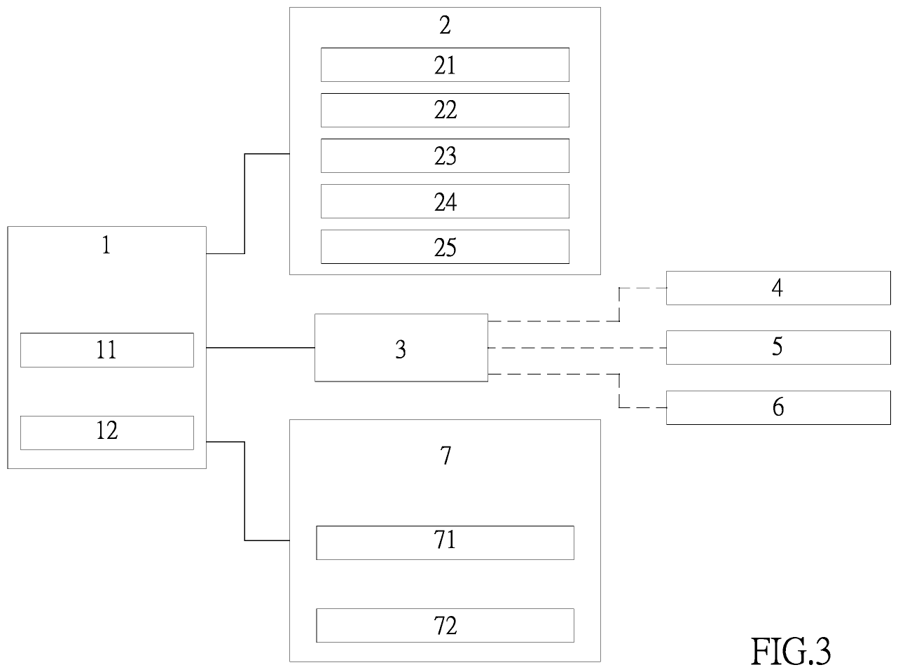

Referring to FIGS. 1 to 3, the intelligent logistics truck scheduling system of the present invention comprises a truck service section 1, a truck scheduling section 2, and a storage service section 7. The truck scheduling section 2 includes a truck company database 21, an idle truck monitoring module 22, a truck distance judgment module 23, a truck selection module 24, and a truck assignment module 25. The truck distance judgment module 23 provides a GPS to each driver so as to report the position of the truck regularly and in real-time, such that the idle truck and the distance between the idle truck and the container location can be judged. The truck tracking unit 3 obtains the current location information of the goods by matching the information feedback from the warehouse location data system 4, the cargo receiving and sending location system 5, and the truck transportation location system 6.

The intelligent logistics truck scheduling system process comprises a demand judgment step S1: a demand judgment module 11 of a truck service section 1 judging whether a client needs a truck service, if the truck service is not needed, a billing and payment step S4 is proceeded, if the truck service is needed, the truck scheduling, container lifting and delivery step S2 is proceeded;
the truck scheduling, container lifting and delivery step S2: the truck service section 1 including a truck scheduling section 2, the truck scheduling section 2 reading a truck company database 21 to obtain a truck information and a driver information, the truck scheduling section 2 using a network module 12 of the truck service section 1 to connect to multiple truck companies networks, an idle truck monitoring module 22 monitoring idle trucks and idle drivers of the truck companies in real-time, a truck distance judgment module 23 being used to judge a distance between a container lifting location and each idle truck, a truck selection module 24 selecting the truck that is located closest to the container lifting location and sending a corresponding information to a truck assignment module 25, the truck assignment module 25 sending an instruction to the selected truck and the driver through internet to carry out container lifting and delivery, after assignment, a truck tracking section 3 being used to determine a current transportation location of the container, after the truck scheduling, container lifting, and delivery step S2 is completed, a storage judgment step S3 is proceeded, and
the storage judgment step S3: a storage demand judgment module 71 of a storage service section 7 judging whether the client has a storage demand, if no storage demand is needed, the billing and payment step S4 is proceeded, if a storage demand is needed, after goods stored in a warehouse and a warehouse management is completed, the billing and payment step S4 is proceeded, and
the billing and payment step S4: the truck service section 1 consolidating funds and issuing a bill for payment to the client.

Compared to the conventional truck scheduling systems, most of the steps have been changed to automation. This improves the efficiency of the truck scheduling system in operation by reducing the need for human communication through various means such as email, phone, and text messages with clients, truck companies, and drivers for coordinating truck pickup times and locations repeatedly.

In the storage judgment step S3, if there is a completed storage, a dedicated storage app judgment module 72 is used to determine whether the storage company has issued an independent and dedicated app and whether the client is using the app. If the storage company has issued the independent and dedicated app and the client is using the app, an app invoice receipt is issued, otherwise the billing and payment step S4 is proceeded.

While we have shown and described the embodiment in accordance with the present invention, it should be clear to those skilled in the art that further embodiments may be made without departing from the scope of the present invention.

What is claimed is:

1. An intelligent logistics truck scheduling system process comprising:
a demand judgment step: a demand judgment module of a truck service section judging whether a client needs a truck service, if the truck service is not needed, a billing and payment step is proceeded, if the truck service is needed, the truck scheduling, container lifting and delivery step is proceeded;
the truck scheduling, container lifting and delivery step: the truck service section including a truck scheduling section, the truck scheduling section reading a truck company database to obtain a truck information and a driver information, the truck scheduling section using a network module of the truck service section to connect to multiple truck companies networks, an idle truck monitoring module monitoring idle trucks and idle drivers of the truck companies in real-time, a truck distance judgment module being used to judge a distance between a container lifting location and each idle truck, a truck selection module selecting the truck that is located closest to the container lifting location and sending a corresponding information to a truck assignment module, the truck assignment module sending an instruction to the selected truck and the driver through internet to carry out container lifting and delivery, after assignment, a truck tracking section being used to determine a current transportation location of the container, after the truck scheduling, container lifting, and delivery step is completed, a storage judgment step is proceeded, and
the storage judgment step: a storage demand judgment module of a storage service section judging whether the client has a storage demand, if no storage demand is needed, the billing and payment step is proceeded, if a storage demand is needed, after goods stored in a warehouse and a warehouse management is completed, the billing and payment step is proceeded, and
the billing and payment step: the truck service section consolidating funds and issuing a bill for payment to the client.

2. The intelligent logistics truck scheduling system process as claimed in claim 1, wherein in the storage judgment step, if there is a completed storage, a dedicated storage app judgment module is used to determine whether the storage company has issued an independent dedicated app and whether the client is using the app, if the storage company has issued the independent dedicated app and the client is using the app, an app invoice receipt is issued, otherwise the billing and payment step is proceeded.
